(19) United States
(12) Patent Application Publication
(10) Pub. No.: US 2002/0191011 A1
(43) Pub. Date: Dec. 19, 2002

(54) Virtual remote touch system

(76) Inventor: Firooz Rasouli, Midlothian, VA (US)

Correspondence Address: Welsh & Katz, Ltd., Bryan C. Wallace, 22nd Floor, 120 South Riverside Plaza, Chicago, IL, 60606, US

(21) Appl. No.: 09/873,476

(22) Filed: Jun. 4, 2001

(51) Int. Cl. G09G 5/00

(52) U.S. Cl. 345/702

(57) ABSTRACT

A virtual remote touching system, for enabling a broadcasting user to transmit tactile characteristic information to a receiving user. The virtual remote touching system comprises an at least one sensing broadcasting unit capable of sensing a broadcasting user's tactile characteristic data and creating an electronic simulation data of said characteristics.

The virtual remote touching system further comprises a transmitting system for sending said electronic simulation data from said sensing broadcasting unit to a receiving device.

Additionally, the virtual remote touching system comprises an at least one simulating unit, for receiving electronic simulation data and simulating tactile characteristics of a broadcasting user, such that an engaging receiving user can touch simulated characteristics of the broadcasting user.

### BACKGROUND OF THE INVENTION

The present invention relates generally to a virtual-reality-type computer interfacing apparatus. More particularly, the present invention is a computer interfacing apparatus for detecting and transmitting the broadcasting user's tactile information to a remote interface, enabling a remote user to virtually feel the broadcasting user's touch.

Over the past twenty years, technological advances in computerized systems, particularly those related to telecommunication, Internet communication and virtual reality, have grown phenomenally. Internet technology enables users around the world to communicate, interact, and share information with each other at relatively high rates of speed. It is estimated that in 2001 over one hundred million users are communicating in cyberspace, over the Internet, via email and on web sites, sharing all forms of information.

Virtual reality technology generally enables users to interface and interact with computers and each other in local computer simulated environments. U.S. Pat. No. 6,028,593, to Rosenberg et al, discloses a method and apparatus for providing simulated physical interactions within computer generated environments. The '593 patent discloses a computer-implemented method which simulates the interaction of virtual objects displayed to a user who controls one of the virtual objects by manipulating an interface device.

U.S. Pat. No. 5,429,140, to Burdea et al, discloses an integrated virtual reality rehabilitation system. The 40 patent discloses a rehabilitation system which employs a force feedback arrangement, such as a force feedback glove, to simulate virtual deformable objects. Prior to rehabilitation, a patient places his or her hand in a sensing glove. The sensing glove measures the force exertable by the patient's digits. Data from the sensing glove is transmitted to a computer where the information is used to diagnose the patient's capability.

U.S. Pat. No. 5,709,219, to Chen et al, discloses a method and apparatus to create a complex tactile sensation. The '219 patent discloses a system for providing haptic or tactile information to a human operator. The system utilizes display devices that dynamically convey touch sensations to the human operator, thereby creating various tactile feelings such as texture and slippage. The system can combine multiple display devices as needed in order to create a specified sense.

Typically, interfacing systems designed to provide tactile simulation are rather limited in their abilities to do so. Conventional means used to simulate tactile sensations include electocutaneous devices, single point simulators driven by electromagnets, vibro-tactile pattern generators driven by electromagnets, and actuators. As disclosed in U.S. Pat. No. 5,165,897, a programmable tactile simulator array system provides a plurality of tactile elements having touch-simulating portions. The touch-simulating portions are moveable between first and second positions by shape memory alloy actuators. Movement of the touch-simulating portions, by means of time varying signals, such as from a programmed computer system, provides tactile feedback to a person using a simulator display.

Advances in computer user interfaces have enabled users to remotely stimulate senses via the Internet. For example, U.S. Pat. No. 6,004,516, to Rasouli et al, discloses an apparatus for generating odor upon electronic signal demand. The '516 patent discloses the use, in association with the users own computer, of a Tele Aroma Drive capable of producing simulated odors in response to remote computer commands. In one embodiment, the user connects to a web site compatible with the aroma apparatus and selects a specific scent from a computer menu. A controller, preferably contained within the disk drive, generates an appropriate thermal or electrical signal to an exhaust and/or disk, in the aroma device, containing an adsorbent. The adsorbent then disseminates the proper concentration of a scent into the user's environment.

Such prior devices and methods have been found suitable for their limited purposes. However, none of the above-mentioned patents disclose a device that allows a user to virtually feel an item, temperature, texture or moisture across cyberspace.

It would be desirable to provide a virtual remote touch system, which enables broadcasting users to send tactile information to remote users, such that the remote users can feel simulations of the touch, moisture, temperature, vibration and other tactile characteristics of the broadcasting users, so as to simulate a touch, feel and/or handshake.

It would further be desirable to provide a device that allows users to virtually feel across cyberspace, that is economical to construct and which is easy to use.

### BRIEF SUMMARY OF THE INVENTION

It is desirable to provide a virtual remote touching system, for enabling a broadcasting user to transmit tactile characteristic information to a receiving user. The virtual remote touching system comprises an at least one sensing broadcasting unit capable of sensing a broadcasting user's tactile characteristic data and creating an electronic simulation data of said characteristics.

The virtual remote touching system further comprises a transmitting system for sending said electronic simulation data from said sensing broadcasting unit to a receiving device. The virtual remote touching system further comprises an at least one simulating unit, for receiving electronic simulation data and simulating tactile characteristics of a broadcasting user, such that an engaging receiving user can touch simulated characteristics of the broadcasting user.

In one embodiment of the present invention, the simulation data is transmitted between the broadcasting unit and the receiving unit via the Internet.

In another embodiment of the present invention, the simulation data is transmitted between the broadcasting unit and the receiving unit in real-time, such that the receiving user can instantly detect a real-time simulation of the broadcasting user's tactile characteristics.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is a schematic representation of one embodiment of a virtual touch device of the present invention;

FIG. 2 is a perspective view of a preferred embodiment of the broadcasting unit of the present invention;

FIG. 3 is a plan view of an interfacing device used in one embodiment of the present invention;

FIG. 4 is a plan view of another interfacing device used in an embodiment of the present invention;

FIG. 5 is a plan view of another interfacing device used in an embodiment of the present invention;

FIG. 6 is a perspective view of a preferred embodiment of the simulating unit of the present invention.

### DETAILED DESCRIPTION OF THE INVENTION

While the present invention is susceptible of embodiment in various forms, there is shown in the drawings an embodiment of the present invention that is discussed in greater detail hereafter. It should be understood that the present disclosure is to be considered as an exemplification of the present invention, and is not intended to limit the invention to the specific embodiment illustrated. It should be further understood that the title of this section of this application (“Detailed Description Of The Invention”) relates to a requirement of the United States Patent Office, and should not be found to be limiting to the subject matter disclosed herein.

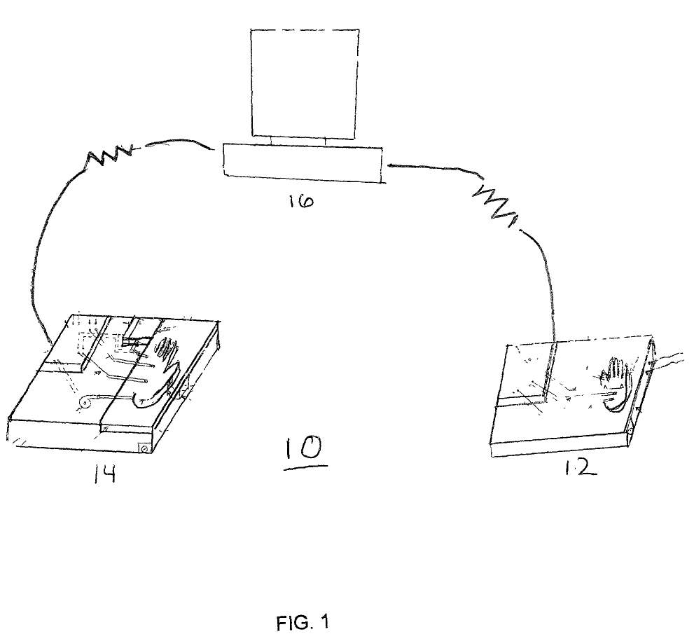

Referring now to the drawings, a virtual remote touch unit 10, made in accordance with one embodiment of the present invention, is shown in FIG. 1. Virtual remote unit 10 comprises a broadcast-interfacing unit 12 and a receiver-simulating unit 14. Broadcasting unit 12 and/or simulating unit 14, are electronically connected to an electronic communication-processing system 16, such as a computer, a Personal Digital Assistant (PDA) or like system known to those skilled in the art.

Electronic system 16 enables a broadcasting user to communicate and/or exchange data with a remote receiving user, using conventional forms of communication such as the Internet, telecommunication devices and systems, wireless communication devices and systems, satellite communication devices and systems and other devices and systems known to those skilled in the art. It is contemplated that the system can exchange data with the remote user in real-time, using real-time methods or instant messaging applications, known to those skilled in the art.

Further, it is contemplated that system 16 uses conventional programming instrumentation generally known to those skilled in the art. Two examples of such are Command line based, which uses programs, such as QuickBASIC, and graphical icon based. Command line based programming, such as QuickBASIC, controls external instruments from a PC via the General Purpose Interface BUS (GPIB). Graphical icon based programming uses graphical virtual programming software packages, such as Labview™, Strawberry™, DaisyLab™ or the like.

System 16, in conjunction with such codes, performs data acquisition, monitoring, analysis and control. Notably, it is contemplated that system 16 can use other applications known to those skilled in the art to perform data acquisition, monitoring, analysis and control functions without departing from the scope of the present invention.

System 16 converts and saves data in an electronic file or data stream format, which can be stored on a hard drive, a floppy or ZIP disc, a DVD-ROM or a like storage mechanism device or system well known to persons having skill in the art. In addition, system 16 is capable of transmitting electronic data, enabling a user to send an electronic data stream to a remote receiving/processing system (not shown).

Sensors 23, comprising sensors 24, 26, 28 and 30 detect characteristic data from the broadcasting user. In the use of virtual system 10 of the present invention, data is collected using sensors 23, which generate an electronic signal, and electronically transferred to a data acquisition board 22. Notably, sensors 23 can be any type of detecting instrument, transducer, test probe or fixture used for transferring the signals to data acquisition board 22 for processing.

It is contemplated that the data acquisition board 22 can be a digital device, an analog input-output device, or any other device capable of collecting and/or measuring electrical signals from sensors and other connected instruments. If desired, data acquisition board 22 can be used in a variety of applications, such as, on/off sensing of contacts or sensors, switching signals, interfacing system 16 to external equipment, or testing digital communication devices.

Virtual remote touch unit 10 uses sensory broadcasting unit 12 to detect a broadcasting user's tactile characteristics, such as the texture, temperature and moisture content of skin, and electronically transmits or stores the data. It is to be understood that storage of data can be accomplished using any known electronic or mechanical data storage means, such as a hard drive, a floppy disk, zip drive, or any other device well known to those having skill in the art. The tactile information can then be electronically sent to the receiving user's electronic system or unit 14. It is contemplated that the tactile data can be sent using the Internet, telephone line, or other communications means or systems known to those skilled in the are. Upon receiving the tactile information, the simulating interface unit 14 can then create a simulation of the tactile characteristics of the broadcasting user, such that the receiving user senses a virtual “touching” of the broadcasting user.

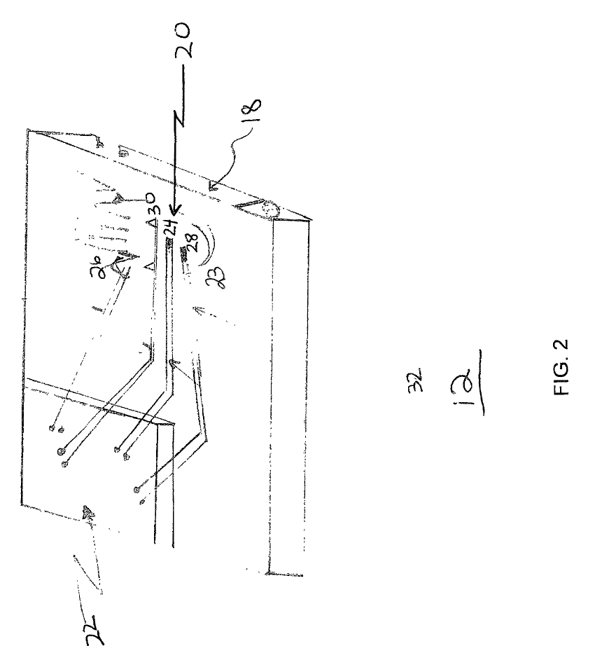

Referring now to FIG. 2, a broadcasting interface unit 12, in accordance with one embodiment of the present invention is shown. The broadcasting-interface unit 12 comprises an interfacing device 20, a base 18, sensors 23 comprising sensing means 24, 26, 28, and 30 and a data acquisition board 22. The interfacing device 20 is distinctly configured for sensing and/or detecting selected tactile qualities of the broadcasting user's interfacing body part or parts. While interfacing device 20 is illustrated as having the shape of a hand, it is to be understood that any body part shape or, any other shape, such as a foot, a leg, a tongue, lips, head, finger, or other part, without departing from the novel scope of the invention. Tactile information signals received from the sensors 23 are collected and compiled, using a conventional data acquisition board 22, and converted into electronic data for storage and and/or transmittal.

Base 18 provides broadcasting unit 12 with stabilized support for positioning unit 12 on a surface. Notably, it is contemplated that base 18 may have virtually any shape, without departing from the novel scope of the present invention. As illustrated, user-interface 20 can be configured in the shape of a glove, or a hand shaped flat surface in fabricated from a polymeric material, enabling receivable engagement with a human hand. Notably, it is contemplated that the user-interfacing device 20 can be configured for receivable engagement with any desired body part of the broadcasting user. In the illustrated embodiment, interfacing-device 20 is configured to receive the transmitting user's hand. Notably, interfacing-device 20 can have a right hand or left hand configuration.

Interfacing-device 20 can be constructed of any one or more of a plurality of materials, including plastic, rubber, metal, and others. Preferably, interfacing-device 20 is comprised of a flexible material, such as porous, semi-porous silicone rubber, hydrogel, poly N-iso-propyl-acrylamide, or a similar polymeric material such as those commonly used to fabricate artificial limbs. The use of a flexible material in the interfacing device's configuration, enables device 20 to conform to the shape of a body part. Preferably, the material used to construct interfacing-device 20 is of a relatively thin cross section. Preferably the thickness of the polymer material is in the range of 0.5-2 mm, and more preferably 1 mm.

The thin material cross section enables associated sensors 23 to more accurately detect qualities of the user's interfacing body part, when the body part is placed in contacting engagement with interfacing-device 20. The thin polymeric material simulates the qualities of human skin forming a skin layer. Underneath the skin layer is a reactive layer of polymer or gel compounds, which provide a soft cushion. It is contemplated that responsive elements as well as sensors 23 can be contained inside of the reactive layer.

Sensors 23, or other sensing devices, are connected to, or associated with the user interface 20, so as to detect tactile sensory characteristics from the interfacing body part. The selected sensors 23 can either be inserted into an underlying reactive layer of user interface 20, or connected to the exterior surface 21 of interface 20.

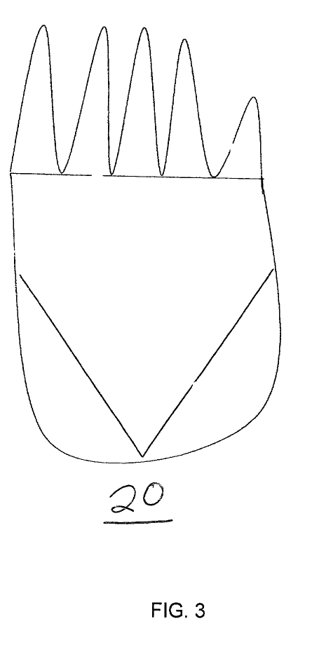

Sensors 23 are located at various selected locations in interfacing-device 20 as shown in FIG. 3, which enables the broadcasting unit 12 to detect the tactile sensory characteristics at different locations on the body part. As shown in FIG. 3, for example, interfacing-device 20 is configured such that sensors 23, comprising sensors 24, 26, 28 and 30 can detect sensory characteristics in eight different areas of a hand.

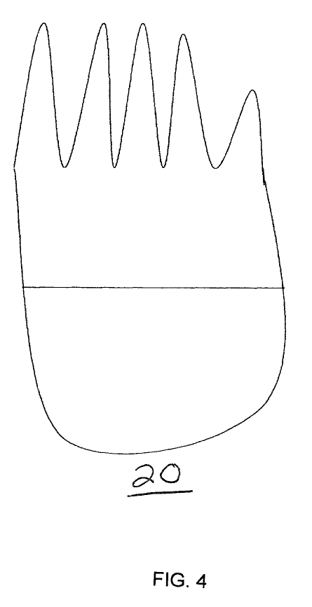

FIG. 4 illustrates a sensor configuration, on interfacing device 20, providing two areas of detection. In order to more accurately detect and simulate tactile sensations, it is preferable to provide as many detecting areas and sensors as possible. It is contemplated that interfacing device 20 can have multiple sensors located in various detection areas, without departing from the novel scope of the present invention.

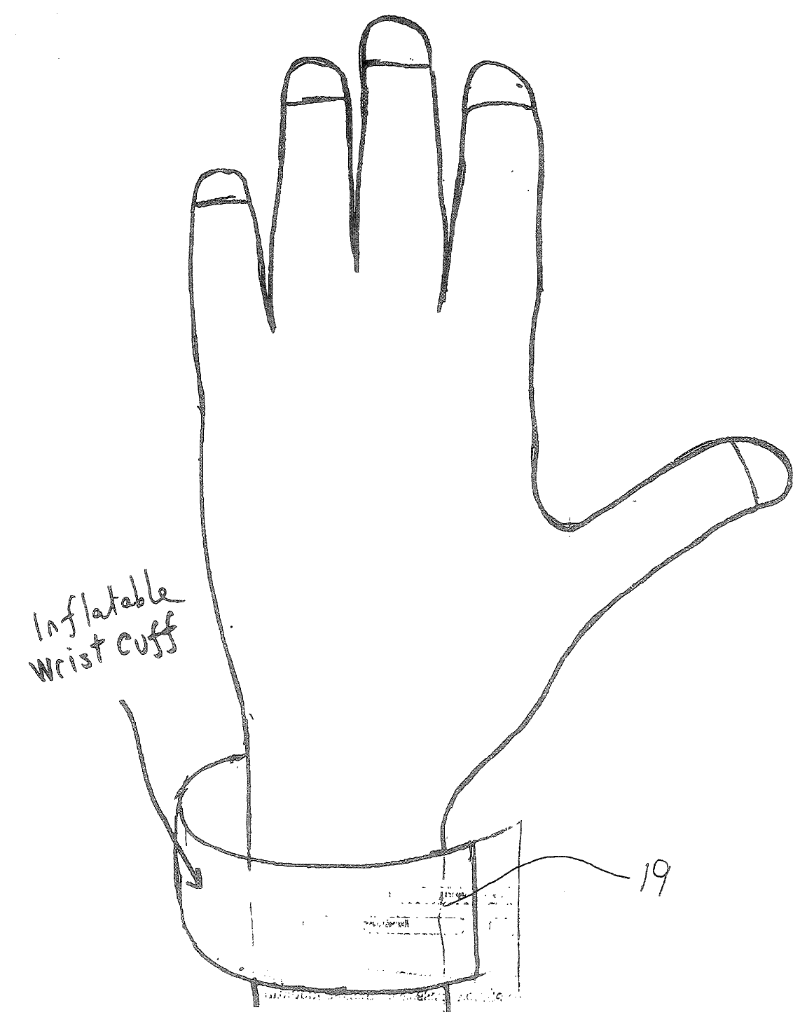

FIG. 5 shows a movement detector 19, for detecting the movement of the interfacing body part. As shown, the movement detector can be configured in a wrist cuff-like configuration, such that the detector can detect the pulse of the broadcasting user.

In the preferred embodiment, sensors 23 detect selected tactile data and, using broadcasting computer interface 12, or other electronic means and relay the tactile characteristic data to data acquisition board 22 for processing. Data processing can include, but is not limited to, compilation, storage, comparison and averaging.

In one embodiment, sensor 30 can be a temperature sensor. Sensor 30 includes a probe, or a series of probes, which engages the interfacing body part at selected areas. During engagement, temperature sensor 30 detects the temperature of the interfacing body part, and sends a signal relaying the information to the data acquisition board 22. Preferably, temperature sensor 30 can be a thermocouple, or a like device, capable of taking temperature measurements. It is contemplated that the temperature range of the device will be between 94-108 degrees Fahrenheit, preferably about 98.6 degrees Fahrenheit.

Sensor 24 can be a moisture sensor for detecting the moisture content of the surface of the interfacing body part. Moisture sensor 24 can be a multi-functional instrument that measures skin impedance to determine the moisture qualities of the skin, such as the DPM 9000 series by NOVA™. Preferably, the skin impedance instrument is designed to provide a non-invasive method for quantifying biophysical characteristics and relative hydration (i.e. moisture) of skin. When sensor probe 24 is placed on the skin or surface of the interfacing body part, sensor 24 relays a signal ranging between 90-999 DPM units. Based off of this reading, a correlation can be made to determine conventional relative humidity units. Notably, it is to be understood that any device or sensor capable detecting skin moisture can be used, without departing from the novel scope of the present invention. In addition, it is preferable that moisture instrument have a fast response capable of detecting moisture data instantly. The tactile moisture data signal is relayed to data acquisition board 22 and can be processed as the other data noted above.

In the present embodiment, virtual touch unit 10 further comprises a surface sensor 28 for detecting the roughness characteristics of the interfacing body part. Preferably, surface sensor 28 can detect the myriad of grooves, creases, indentations, and other textures and textures of the skin. It is contemplated that sensor 28 can be special purpose instrument used for measuring the skin roughness in dermatology. For example, the Stylus based profilometer such as DETAK Stylus Profiler or Hommeltester are instruments suitable of providing accurate surface roughness of the surface.

In an alternative embodiment of the present invention, sensor 28 is a capacitance based measurement system, which provides an average of the surface roughness. It is preferred that the capacitance based measurement device have a compact configuration, is non-invasive, does not have a moving part and does not scratch the surface. One such example of this type of instrument is a Surfmaster™ 19500.

In another example, piezoelectric based sensors such as Flexbar™ 15950, which operates based on contact, can be used to detect the surface of the interfacing part.

Piezoelectricity arises in certain crystals, notably quartz, which because of geometric configurations of their atoms exhibit an independence between mechanical deformation and electrical polarization. When such a crystal is strained by an applied force, the distortion of the lattice results in charge appearing at the surfaces of the sample.

In another embodiment, skin surface roughness can be determined using established linear correlation between skin roughness and the detected skin moisture using content known to those skilled in the art. Notably, any means for detecting the roughness characteristic of a body part can be employed without departing from the novel scope of the present invention.

Detected signals can be relayed to the data acquisition board 22 using wire 32, or other form of signal transmitting means without departing from the novel scope of the present invention.

In the present embodiment, a hardness detector 26 can be utilized to detect the hardness of the body part. In one embodiment, a hardness detector 26 can be comprised of two or more small components that apply a penetrating contact force to the surface of the skin to measure the level of penetration, allowed by the skin. A body part having a harder surface quality will allow only a shallow penetration compared to that of a softer surface quality. Other forms of measuring or detecting the hardness of the skin can be used to determine the hardness quality of the body part, without departing from the novel scope of the present invention. It is understood that a hardness detector 26 can be of a relatively basic or complex form of types known to persons having skill in the art.

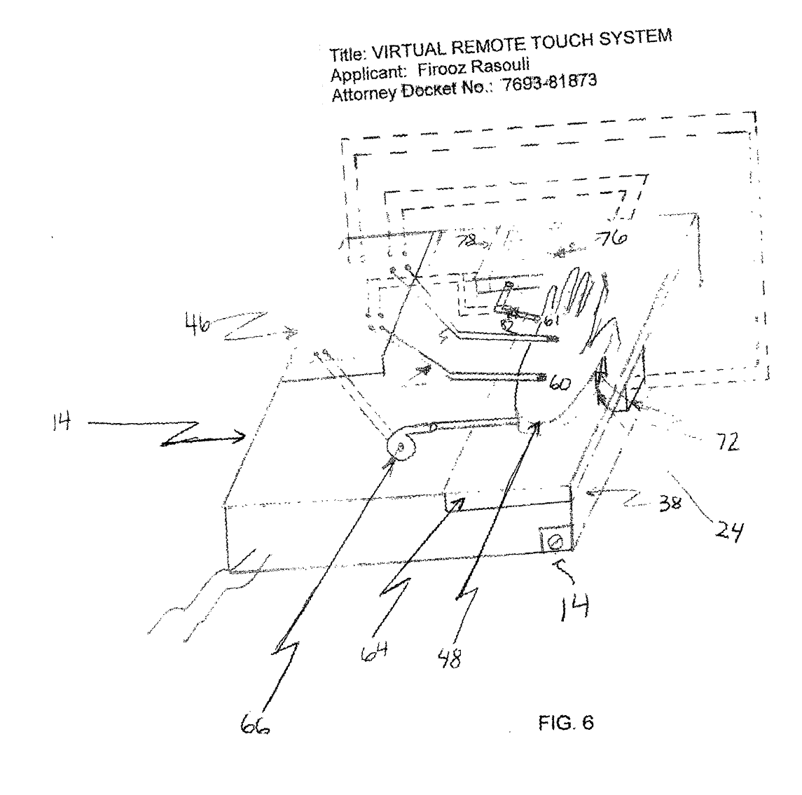

Referring now to FIG. 6, a preferred embodiment of an interfacing simulating unit 14 is illustrated. In the present embodiment, simulating unit 14 is connected to a communicating system 16. System 16 can be a computer, personal digital assistant (PDA) or any other system or device, capable of receiving and/or and transmitting electronic data using the Internet, telecommunication, satellite transmission or other forms of communication. System 16 can receive electronically transmitted data and send the data to an interfacing simulating unit 14. If the electronic data is in a data file or stream form, the communication system of the present embodiment is capable of retrieving the data from the stream, or transferring the data to a processing system 16.

Interfacing simulating unit 14 uses electronic data, received from system 16, to create a simulation of the broadcasting user's tactile characteristics. A receiving user interfaces with unit 14 to feel a simulated “touch” of the broadcasting user. Simulating unit 14 comprises a base 38 a controller 46 and an interfacing receiving device 48.

Controller 46 controls the operation of receiver unit 14, to create a feeling inside of interfacing device 48 similar to that of the simulated touch created by the broadcasting user. Controller 46 receives referencing data detailing tactile characteristics of the broadcasting user from processing system 16. Controller 46 receives a data signal from sensors 59, comprising sensors 60, 61, 62, and 63. Controller 46 processes data from sensors 59, and compares the data to the input tactile data received from the broadcaster, in order to regulate the heating/cooling, moisturizing, pulsating and texture simulation in the interfacing device 48.

In order to interface with simulating unit 14, the receiving user must either place his or her body part inside of, or in adjacent touching position with, interfacing receiving device 48. Simulated characteristics of the broadcasting user transmitted from the broadcasting unit 12, such as the hardness, skin moisture, skin texture, temperature and other tactile qualities, are recreated inside of the interfacing device 48, such that the interfacing user can virtually “touch” or “feel” the “touch” of the broadcasting user, using simulating devices.

Interfacing device 48 can be comprised of a thin, porous or semi-porous natural or synthetic polymeric material or like material, which imitates the characteristics of skin. The polymer material is of a silicone rubber, hydrogel, poly-N-isopropylacrylamide, or other various polymeric materials used to fabricate artificial limbs

The environment beneath the skin layer can be a reactive layer of soft polymer or gel-like compounds for providing a soft cushion-like feel, which mimics the feel of a human hand. The reactive layer can contain sensors 23 and responsive elements. The reactive layer can have a desired variable thickness. Preferably, the reactive layer has thickness between 10 to 20 mm, and more preferably 15 mm. In addition, the gel-like compound can be mixed with temperature responsive hydrophillic gels that release moisture upon heating.

Interfacing device 48 is configured in a selected shape of the interfacing receiving body part (not shown). The receiving body part (not shown) can be a hand, a tongue, lips, an arm, a foot or any other body part, without departing from the scope of the present invention.

Sensors 59, comprising 60, 61, 62 and 63, are placed inside or on the surface (not shown) of interfacing device 48 to measure and/or detect characteristics inside or on the surface of the device 48. As previously illustrated in FIGS. 2 and 3, the broadcasting and/or receiving interfacing devices 48 and 20 can be divided into separate areas. Division of interfacing device 48 into separate areas enhances detection and sensing accuracy, thereby enabling the controller 46 to detect environmental qualities at the various locations.

It is understood that the average human sustains a body temperature of about 98.6 degrees Fahrenheit, however, the temperature of a persons particular body part may vary person to person, depending on body chemistry, and other factors. The surface temperature of the transmitting user's body part also varies, depending on the temperature of the body part's surrounding environment. To enhance the simulation capabilities of simulating unit 14, it is important that unit 14 accurately recreates the temperature qualities, inside of interfacing device 48, of user's interfacing simulating body part. To account for variances in the broadcasting user's temperature, a temperature sensor 60 or plurality of temperature sensors can be positioned inside of the interfacing device 48 to detect the temperature inside of device 48. Preferably, temperature sensor 60 is a fast response temperature sensor such as a thermocouple or a similar device. Temperature data is sent from the sensor 48 through a transmitting cable or wire 62, to the connected controller 46.

Controller 46 reads the temperature data and compares the temperature inside of interfacing device 48 to that of the temperature of the broadcasting user's body part. Based on this comparison, controller 46 sends a signal to a temperature regulator or regulating assembly 64, to either warm up or cool down the environment inside of interfacing device 48, such that interfacing device 48 has the transmitted temperature qualities of the broadcasting user. Controller 46 controls the temperature inside of the interfacing device 48 by turning temperature regulator 64 on or off.

Notably, without departing from the scope of the present invention, temperature regulator 64 can be any type of instrument or device known to one skilled in the art, for heating or cooling surfaces, such as a conventional heater, a plurality of small heaters, or a thermoelectric (TE) device.

As known to those skilled in the art, TE devices use the Perltier principle to create electrical heating or cooling on demand. When a current flows across a junction of two dissimilar conductors, heat is absorbed or liberated at the junction, dependent upon the direction of current flow referred to as a Peltier effect. Therefore, by reversing the direction of the current, a TE device can be used to heat and cool without any refrigerants. TE systems are very reliable, quiet, and almost maintenance-free. A TE unit can be adjusted, and precisely controlled by a microprocessor, such as microprocessor (not shown) in processing system 16.

In the preferred embodiment, simulating unit 14 can further comprise pulsating means 72. Pulsating means 72 can vibrate or otherwise create a pulse to simulate the level of pulse or vibration of the broadcasting user's body part. It is to be understood that pulsating means 72 can be any type of vibrator, motor, pulsar or the like, well known to those having skilled in the art, without departing from the scope of the present invention. In the preferred embodiment, pulsating means 72 can be placed in contacting relationship to the interfacing device 48, such that the receiving user can sense the pulsation of the device 72. A wire or cable or signal transmitting device is used to transmit a signal to the pulsating means 72 from interconnected controller 46.

Because the moisture content of the body can range anywhere between sweaty to extremely dry, it is important to recreate the broadcasting user's moisture touch characteristics inside of the receiving device 48. In this manner, the receiving user can feel the broadcaster's moisture qualities. To recreate touch characteristics, a moisture sensor 61 or other moisture detecting means, is placed inside of, or in adjacent contact with receiving device 48.

Moisture sensor 61 can sense the moisture content of the inside of the interfacing device 48 and then send a signal back to the controller. The data signal can indicate the level of moisture within the interfacing device's 48 environment. Controller 46 can then compare the moisture level of the broadcasting users data to that of the moisture level detected inside of the interfacing device 48. In one embodiment, if the moisture level inside of the interfacing device 48 is less than that of the broadcasting user's moisture level, controller 46 can then send a signal to a moisturizing element 76 to create moisture inside of interfacing device 48. In this manner the moisture level is raised to the desired broadcaster's touch moisture level.

Moisturizing element 76 can be constructed of a temperature responsive material. It is to be understood that the moisturizing element can be can be any type of material capable of creating moisture, including but not limited to a hydrophilic gel, silica gel, a moisturizing gel, or any other material known to those having skill in the art. Moisturizing element 76 can be placed relatively close to interfacing device 48 such that moisture released from element 76 is transferred to device 48.

In a preferred embodiment, moisturizing element 76 is contained in a storage housing 80. In order to cause element 76 to release moisture, a heater 78 can be placed underneath moisturizing element 76 to heat the moisturizing element 76. The moisture can then permeate into an electronic valve 82 and is transferred, or injected, into the interfacing device 48.

If the moisture level detected by the moisture sensor is greater than that of the broadcasting user's moisture level, the interfacing unit 14, which comprises a simulating device such as a drying apparatus such as a blower 66, causes a drying action. Blower 66 is in connective contact with device 48. To lower the moisture level inside of the receiving device 48, blower 66 can blow air into or onto device 48, thereby removing moisture. Valve 82 is opened to enable air to flow from the receiving device 48, further removing moisture.

Receiving device 48 is further comprised of a responsive material (not shown) whose texture characteristics can be changed to simulate the texture characteristics the broadcaster's skin, by duplicating tactile roughness qualities. A conductive polymer capable of changing its texture responsive to an electrical signal can be used. Preferably, the responsive material has similar characteristics to that of skin and is capable of changing its texture responsive to an electrical signal. The responsive material can be manipulated by controlling the level of a stimulus, which is controlled by controller 46. It is contemplated that the responsive material can be any material that changes its geometrical and/or physical properties in response to a stimulus, such as temperature, light, electricity, etc.

In another embodiment, the responsive material layer can contain some bumps on the outer layer. Based on a given signal, an interior gel inside of the layer can expand or contract eliminating or amplifying the surface texture inside interface 48.

In another example, the texture of the inner surface of interfacing device 48 can be controlled using a textured polymer. The polymer can be wrinkled to represent a human skin layer. To recreate the texture qualities of the broadcasting user's skin, receiving device 48 is pressurized underneath the skin layer, using pressurizing means, such as a small air blower, or a piston. Pressurization of the underlying layer tightens the layer of simulated skin, thereby removing wrinkles from the surface of the simulated skin, creating a soft texture. Upon depressurization of interfacing device 48, wrinkles reappear, thereby simulating a rough texture. In yet another embodiment, the wrinkles can be reversibly altered in response to temperature.

As illustrated in FIG. 1, the broadcasting unit and simulating unit can be separate interfaces. However, it is understood that broadcasting and simulating units 12 and 14 can also be configured as one integral unit (not shown). In this configuration, the interfacing user can simultaneously be a receiver as well as a broadcaster, using the same engaging body part with a tactile sensing interface.

In the use of devices described above, a broadcasting user turns on system 16, which as previously stated can be a computer, PDA or the like communicating device. The broadcasting user turns on the virtual remote touch unit 10 and places his or her interfacing body part into the broadcasting interface 20 of unit 12. Sensors 23 detect tactile characteristics of the broadcasting user's engaging body part, such as temperature, moisture, pulse, hardness and other tactile characteristics, and transmits a data signal to a data acquisition device 22. Data acquisition device 22 compiles the temperature moisture, pulse, hardness data and other vital information, processes the information and writes the information to an electronic data stream.

The broadcasting user sends the data stream to a remote receiving unit, similar to that of simulating unit 14. It is understood that the remote receiving unit can be any type of unit capable of in converting electronic tactile information into a simulated environment.

A remotely connected receiver who receives the tactile information opens the tactile data stream using a processing system such as a computer or the like. The receiving user interfaces with a simulating unit 14 by placing his or her body part in contact with receiving device 48. The processing system 16 opens the data stream and sends signals to the controller 46. Controller 46, using sensors 49, detects the environment inside of or on the surface of interfacing unit 48 to determine the temperature, texture, hardness, moisture, and other qualities. Controller 46 compares the data signals from the sensors to that of the transmitted information from the broadcasting user. Controller 46 adjusts the qualities to that of the broadcasting user.

What is claimed is:

1) A virtual remote touching system, for enabling a broadcasting user to transmit tactile characteristic information to a receiving user, comprising:
at least one sensing broadcasting unit, capable of sensing the broadcasting user's tactile characteristics and creating electronic simulation data of said characteristics;
a transmitting system for sending said electronic simulation data from said sensing broadcasting unit to a receiving device;
at least one receiving simulating unit, capable of receiving electronic simulation data, such that an engaging receiving user can touch the simulated tactile characteristics of the broadcasting user.

2) The virtual remote touching system of claim 1, wherein the simulation data is electronically transmitted between the broadcasting unit and receiving unit by using the Internet.

3) The virtual remote touching system of claim 1, wherein the simulation data stream is electronically exchanged between the broadcasting unit and the receiving unit using a real-time Internet application, such that the receiving user can instantly touch simulated tactile characteristics of the broadcasting user.

4) The virtual remote touching system of claim 1, wherein said sensing broadcasting unit comprises a broadcasting device, a base, at least one sensor, and a data acquisition device.

5) The virtual remote touching system of claim 4, wherein said broadcasting device engageably receives at least one body part from said broadcasting user,
said at least one tactile detecting sensor is connected to the broadcasting device, so as to detect selected characteristic data of the at least one engaging body part,
said broadcasting device generates an indicating signal, and said indicating signal is received by said data acquisition device.

6) The virtual remote touching system as in claim 1,
wherein said simulating unit comprises a processing system, a controller, a receiving device, a base, an at least one sensor and said receiving device is configured to engageably receive an at least one interfacing body part from said receiving user.

7) The virtual remote touching system of claim 6, wherein said at least one sensor is connected to said broadcasting device for detecting selected tactile characteristic data of said at least one engaging body part.

8) The virtual remote touching system of claim 7, wherein said data acquisition device receives a signal from a connected at least one sensor and transmits said information to said transmitting system.

9) The virtual remote touching system of claim 8, wherein said at least one sensor is a temperature sensor for detecting the temperature of the broadcasting user's at least one engaging body part and relaying an indicating signal to said data acquisition device.

10) The virtual remote touching system of claim 8, wherein said at least one sensor is a moisture sensor for detecting the moisture of the broadcasting user's at least one engaging body part and relaying an indicating signal to said data acquisition device.

11) The virtual remote touching system of claim 8, wherein said at least one sensor is a surface sensor, for detecting the roughness characteristic of the at least one engaging body part and relaying an indicating signal to said data acquisition device.

12) The virtual remote touching system of claim 8, wherein said at least one sensor is a hardness sensor, for detecting the hardness of the at least one engaging body part and relaying an indicating data signal to said data acquisition device.

13) The virtual remote touching system of claim 12, wherein an at least one tactile detecting sensor cooperatively engages said receiving device, such that said detecting sensor sends an indicating data signal to said controller,
wherein said controller receives said indicating signal and compares data received from said indicating signal to received electronic simulation data.

14) The virtual remote touching system of claim 12, wherein receiving device is comprised of a synthetic polymeric material.

15) The virtual remote touching system of claim 12, wherein said at least one sensor is a temperature sensor for detecting the temperature of the receiving device and relay an indicating signal to said controller.

16) The virtual remote touching system of claim 12 wherein said at least one sensor is a moisture sensor for sensing the moisture content of the receiving device and relaying an indicating signal to said controller.

17) The virtual remote touching system of claim 12 wherein said at least one sensor is a hardness sensor for detecting the hardness of the inner surface of the receiving device and relaying an indicating signal to said controller.

18) The virtual remote touching system as in claim 12 wherein said receiving interface has a hand shaped configuration.

19) The virtual remote touching system as in claim 12 wherein said receiving interface has lip-like shaped configuration.

20) The virtual remote touching system as in claim 15, further comprising a moisturizing element in connective association with said receiving device, such that a signal from said controller causes the moisturizing element to create moisture into said receiving device.

21) The virtual remote touching system as in claim 12, further comprising a moisture removing apparatus,
said moisture removing apparatus is electronically connected to said controller, such that when said controller sends a controlling signal to said moisture-removing apparatus, said moisture removing apparatus blows drying air in the direction of the receiving device to remove moisture from the receiving.

22) The virtual remote touching system as in claim 12, further comprising a temperature regulating apparatus,
said temperature apparatus is electronically connected to said controller, such that when said controller sends a controlling signal to said temperature regulating apparatus, said apparatus increases or decreases the temperature of the interfacing device.

23) The virtual remote touching system as in claim 12, wherein interfacing device is comprised of a flexible polymer that is capable of responsively deforming in response to a controlling signal, thereby creating a simulation of the texture if the broadcaster's engaging body part.

24) A tactile sensing unit, for sensing an engaging user's tactile characteristic data of a user; comprising:
an interfacing device;
an at least one sensor for detecting tactile data of an engaging user and sending an indicating signal;
a data acquisition apparatus for receiving said indicating signal from said at least one sensor.

25) The tactile sensing unit of claim 24, wherein the sensing unit is a transmitting unit, comprising a broadcasting device, a base, an at least one sensor, and a data acquisition device;
wherein said broadcasting device engageably receives said at least one body part from said broadcasting user;
wherein said at least one sensor is connected to said broadcasting device, to detect tactile characteristic data of at least one engaging body part and creating an indicating signal to be received by said data acquisition device.

26) The tactile sensing unit of claim 24,
wherein said at least one sensor is a temperature sensor for detecting the temperature of the broadcasting user's at least one engaging body part and relaying an indicating signal to said data acquisition device.

27) The tactile sensing unit of claim 24 wherein at least one sensor is a moisture sensor for detecting the moisture of the broadcasting user's at least one engaging body part and relays an indicating signal to connect said data acquisition device.

28) The tactile sensing unit of claim 24, wherein at least one sensor is a hardness sensor that detects the hardness of the at least one engaging body part and relays an indicating signal to said data acquisition device.

29) The tactile sensing unit of claim 24, wherein at least one sensor is a movement sensor capable of detecting the movement or vibration of the engaging body part and relaying an indicating signal to said data acquisition device.

30) The tactile sensing unit of claim 24, wherein the interfacing device has a hand-shaped configuration for engagement with an interfacing user's hand.

31) The tactile sensing unit of claim 24, wherein the interfacing device has a lip-shaped configuration shape for engagement with an interfacing user's lips.

32) The tactile sensing unit of claim 24,
wherein said tactile sensing device is a simulating unit for receiving tactile data from a source,
wherein said simulating unit comprises a receiving device, a base, an at least one sensor, a data processing system and a controller,
wherein said data processing system receives electronic tactile simulation data from a remote source,
wherein said at least one sensor detects selected tactile characteristics and sends a tactile indicating data signal to said controller,
wherein said controller compares said electronic tactile simulation data to that of received tactile indicating data and sends a generating signal to an at least one selected regulating apparatus.

33) The tactile sensing unit of claim 30, wherein said at least one sensor is a temperature sensor for detecting the temperature of the receiving user's said at least one engaging body part and relays an indicating data signal to said controller.

34) The tactile sensing unit of claim 30, wherein said at least one sensor is a moisture sensor for detecting the moisture of the receiving user's said at least one engaging body part and relays an indicating data signal to said controller.

35) The tactile sensing unit of claim 30, wherein said at least one sensor is a surface sensor, for detecting the roughness characteristic of receiving user's said at least one engaging body part and relaying an indicating data signal to said controller.

36) The tactile sensing unit of claim 30, wherein a hardness sensor detects the hardness of receiving user's said at least one engaging body part and relays an indicating data signal to said controller.

37) The tactile sensing unit of claim 30, wherein a vibration sensor detects the movement of the receiving user's said at least one engaging body part and relays an indicating data signal to said controller.

38) The tactile sensing unit of claim 30, wherein said regulating device is a moisture regulator adjacent to said interfacing device, comprised of a moisturizing element reactive to heat such that when heated the moisturizing element releases moisture.

39) The tactile sensing unit of claim 30, wherein said interfacing device is comprised of a flexible polymer that responsively deforms responsive to a signal, thereby forming the texture of a broadcaster's engaging body part.

40) The tactile sensing unit of claim 29, wherein said interfacing device is connected to a temperature regulating device such that the surface temperature of the interfacing device can be controlled to simulate the temperature of the broadcasting user's engaging body part.

41) A method for enabling users to remotely virtually touch, comprising the steps of:
providing a broadcasting-sensing unit comprising an interfacing device capable of receiving a broadcasting user's interfacing body part and sensing tactile characteristics of the body part;
positioning the interfacing body part into an engaging position with the interfacing device, such that the interfacing device can detect tactile characteristics of the interfacing body part;
detecting tactile characteristics of the broadcasting user's interfacing part, such that a data signal containing the detected simulation data is generated;
providing a data acquisition device capable of receiving the data signal and converting the signal into an electronic data form;
transferring the data signal to the data acquisition board;
converting the signal into transferable simulation data stream;
transferring the simulation data stream to a transmitting device;
providing a receiving-simulating unit having a receiving interface, capable of receiving data and converting the simulation data into a tactile simulation, such that a receiving user can touch simulated tactile qualities of the broadcasting user;
transmitting the simulation data to the receiving-simulating unit having a controller capable of converting the data into indicating electronic signals;
positioning the receiving user's body part in an associated engagement with the receiving-simulating interface;
providing a simulating device capable of simulating tactile characteristics;
converting the simulation data into an indicating signal and transmitting the indicating signal to the simulating device;
wherein, when a broadcasting user positions his body part in touching engagement with the broadcasting unit, electronic simulation data is generated and transmitted to a simulating unit having simulation devices, such that a receiving user who engages the simulating unit can feel a simulation of the touch of the broadcasting user.
